(19) United States
(12) Patent Application Publication
(10) Pub. No.: US 2026/0251757 A1
(43) Pub. Date: Aug. 27, 2026

(54) METHOD FOR EVALUATING RADAR SYSTEMS

(71) Applicant: Symeo GmbH, Neubiberg (DE)

(72) Inventors: Yassen Dobrev, Nurnberg (DE); Peter Gulden, Erding (DE); Mark Christmann, Munchen (DE); Michael Gottinger, Buckenhof (DE)

(21) Appl. No.: 19/649,811

(22) Filed: Apr. 16, 2026

Related U.S. Application Data
(63) Continuation of application No. 17/497,910, filed on Oct. 9, 2021, now Pat. No. 12,631,724.
Application No. 17/497,910 is a continuation of application No. PCT/EP2020/058574, filed on Mar. 26, 2020.

(30) Foreign Application Priority Data
Apr. 10, 2019 (DE) 1020190026624

(51) Int. Cl. G01S 7/40; G01S 13/89; G01S 13/931

(52) U.S. Cl. CPC G01S 7/40; G01S 13/89; G01S 13/931

(57) ABSTRACT

The invention relates to method for evaluating, in particular for imaging and/or for a MIMO method, a radar system comprising at least one first radar unit for emitting and receiving signals and at least one second radar unit for emitting and receiving signals, which form a total radar array, wherein only a partial radar array of the total radar array is used in the evaluation.

### RELATED APPLICATION

The present disclosure is a continuation of U.S. patent application Ser. No. 17/497,910, entitled “METHOD FOR EVALUATING RADAR SYSTEMS,” and filed Oct. 9, 2021, which claims priority to, as a bypass continuation, International Patent Application Serial No. PCT/EP2020/058574, entitled “METHOD FOR EVALUATING RADAR SYSTEMS,” and filed Mar. 26, 2020. The International Patent application claims priority to German Patent Application Serial No. 10 2019 002 662.4, entitled “Verfahren zur Auswertung von Radarsystemen,” and filed on Apr. 10, 2019. Each of the foregoing are hereby incorporated by reference in their entirety.

### BRIEF DESCRIPTION OF THE DRAWINGS

FIG. 1 a schematic representation of a radar system according to the

FIG. 2 a section of FIG. 1;

FIG. 3 an image with distinct side lobes;

FIG. 4 radar images;

FIG. 5 a pseudospectrum;

FIG. 6 a pseudospectrum;

FIG. 7 a pseudospectrum;

FIG. 8 a pseudospectrum;

### DESCRIPTION

The invention relates to a method and a device for the evaluation of, in particular, thinned-out radar systems.

State of the art for radar with thinned-out antenna arrangements, often referred to as sparse array, are evaluation methods e.g. according to Hardware Realization of a 2 m×1 m Fully Electronic Real-Time mm-Wave Imaging System, A. Schiessl, A. Genghammer, S. Ahmed, L-P. Schmidt, EUSAR 2012 for imaging and for MiMo methods. This results in high side lobes/diffraction patterns, especially for highly thinned-out arrays, which make practical evaluation very difficult. Moreover, such arrays are often highly extended and therefore not solvable with classical beamformer approaches from the beamformer literature. Particularly often such extended Sparse Arrays occur in distributed radar systems, e.g. according to WO 2018/158281 A1, which establish coherence only in post-processing.

It is object of the invention to propose a comparatively simple and yet precise method for evaluating, in particular for imaging and/or for a Massive Input Massive Output (MIMO) method, of signals of a, in particular, thinned-out radar system. Furthermore, a corresponding evaluation device, a corresponding radar system and a corresponding mobile device shall be proposed.

This object is solved in particular by claim 1.

In particular, the object is solved by a method for evaluating (possibly for imaging and/or for a MIMO method and/or for target detection and/or—localization and/or for a target velocity determination) of signals of a, in particular, thinned-out radar system (spare radar array) and/or of a radar system with large aperture, comprising at least one first radar unit for emitting and/or receiving signals and at least one second radar unit for emitting and/or receiving signals which form a (virtual) total radar array (with antenna channels or physical channels and virtual channels), wherein only a partial radar array of the total radar array is used in (for) the evaluation.

Each radar unit may have at least two (or at least three or at least four) receiving antennas and/or at least (or at least three) two emitting antennas. Several, possibly all, antennas may be arranged on one (straight) line.

The respective radar unit may also be referred to as an emitting-receiving unit.

In total and/or between the two radar units, at least six, preferably at least twelve, possibly at least 20 virtual channels may be formed.

In embodiments, the partial radar array comprises only virtual channels.

Preferably, the referenced partial radar array is located (entirely) between the first radar unit and the second radar unit.

For the partial radar array, possibly all virtual channels between the first radar unit and the second radar unit may be considered.

Preferably, the partial radar array is selected such that a far-field approximation can be used.

At least one target is preferably in the near-field of the total radar array and/or in the far-field of the partial radar array.

Preferably, the evaluation comprises a beamforming.

Preferably, in an evaluation step it is assumed that a position of the target lies on an ellipse with the radar positions in the ellipse focal points. In particular, the ellipse is not a circle. The radar positions can be approximated by a centre point of the antennas of the respective radar unit. It is also advantageously exploited that an error in the radar position due to the curvature of the ellipse has only a minor influence (or becomes relevant only at a multiple of the wavelength).

The evaluation, in particular the beamforming, may involve the application of a window function, in particular a Hann-window.

In the evaluation, beamformer weights may be used, which may be determined beforehand, in particular calculated, possibly from hypothesis vectors, and/or may be stored, whereby in the latter case they are determined only once, in particular calculated, and are used for different radar measurements.

Preferably the evaluation, in particular the beamforming, is adapted such that it is taken into account that the far-field approximation does not apply to the total radar array, but does apply to the partial radar array.

Preferably, a/the target (with respect to cross paths formed by the first and second radar units) is at/in the same range Fast Fourier Transform (FFT) bin.

An emitting frequency of at least one emitting antenna, optionally all emitting antenna is preferably at least 1 GHz, preferably at least 10 GHz, for example 77 GHz.

The above object is further solved by an evaluation device, in particular for carrying out the above or subsequently described method, for evaluating (possibly for imaging and/or for a MIMO method and/or for target detection or localization and/or for a target velocity determination) of signals of a radar system, in particular a thinned-out radar system, comprising at least one first radar unit for emitting and receiving signals and at least one second radar unit for emitting and receiving signals which form a (virtual) total radar array (with antenna channels or physical channels and virtual channels), whereby only a partial radar array of the total radar array is used in the evaluation.

The evaluation device can have at least one (electronic) memory and/or at least one (micro) processor and/or at least one connection for current transmission and/or at least one connection for data transmission.

The above object is further solved by a radar system comprising at least one first radar unit for emitting and receiving signals and at least one second radar unit for emitting and receiving signals forming a (virtual) total radar array, and the evaluation device.

The above object is further solved by a mobile device, in particular vehicle, preferably motor vehicle and/or ship and/or aircraft, further preferably passenger vehicle or truck, comprising the evaluation device and/or the radar system. In embodiments, the first and/or second radar unit, optionally the radar system, may be arranged (integrated) in/on a bumper.

Further embodiments result from the dependent claims.

In the following description, also with reference to accompanying figures, further principles, aspects and embodiments of the invention are described.

In the following description, the same reference numerals are used for identical and like-acting parts.

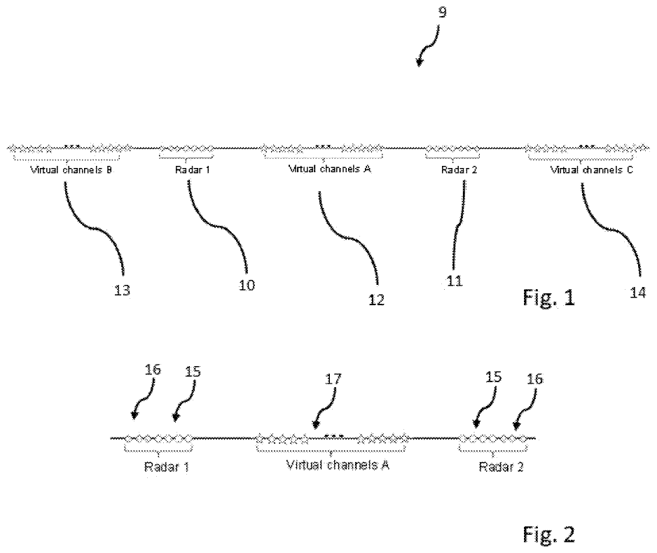

FIGS. 1 and 2 show highly schematically a radar system 9 with two radar units 10 and 11, and groups of virtual channels 12, 13 and 14. The group of virtual channels 12 is arranged between the radar units 10 and 11. Each group of virtual channels may have more than the channels 17 represented by asterisks (e.g. 24 channels). The first and/or the second radar unit may have multiple (e.g. four or more) receiving antennas 15 and/or multiple (e.g. three or more) emitting antennas 16.

In a sparse array according to FIGS. 1 and 2, which may be implemented as a MIMO system with multiple emitting and receiving channels, the additional virtual channels may be represented as being realized as spatial folding as long as far-field approximation is provided. In general only from a target distance of

$$r = \frac{2 \cdot {L}^{2} \cdot f}{c} ,$$

a near-field approximation applies, where L is the spatial extent of the antenna aperture, f is the emitting frequency, and c is the speed of light.

In FIG. 1, it becomes clear how the real and virtual channels form a sparse array.

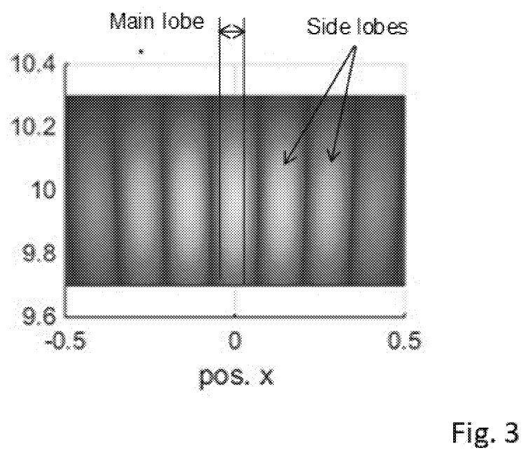

Typically, such arrangements have a narrow main lobe and tall and numerous side lobes. An image acquired with a very thinned-out array is shown exemplary in FIG. 3.

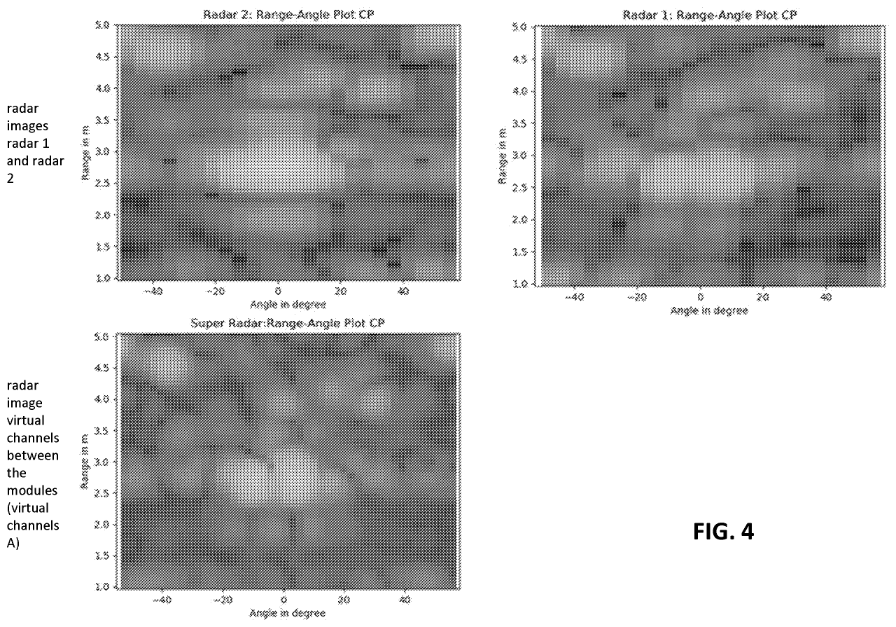

Preferably, from that a sub-arrangement is selected that lies between the two arrays and is less thinned-out (channel group 12 in FIG. 1). Due to the smaller extension, the achievable resolution is reduced, but the side lobes are smaller. FIG. 4 illustrates this by means of two closely spaced targets. It is easy to see that no strong sidelines occur.

Particularly advantageous in this is the use of exclusively virtual array elements in the centre of the array, since these always come to rest in the centre of the two radars due to the spatial folding of the subarrays. The relative spacing of the virtual channels in the centre thereby depends (at least substantially or at least to a first approximation) only on that of the antennas in the modules (radar units 10, 11) with respect to each other. This eliminates the necessity to exactly know the distance between the modules and if necessary to recalibrate for changes due to thermal expansion. Thus, a comparatively elaborate step compared to the state of the art is preferably omitted. Incidentally, this distance can also be inconstant, for example in the case of vibrations.

In principle, any type of beamformer can be applied to the entire array and/or to the partial array. However, in the case of extended (sparse array) antenna arrangements, the far-field approximation is no longer given due to the large extension and the high emitting and receiving frequency of, for example, 77 GHz.

In such cases, a completely holographic solution was chosen according to the state of the art, e.g. A Rotating Synthetic Aperture Radar Imaging Concept for Robot Navigation, F. Ali, G. Bauer and M. Vossiek, IEEE TRANSACTIONS ON MICROWAVE THEORY AND TECHNIQUES, VOL. 62, NO. 7, July 2014. Good results were obtained with this, but they are offset by a very high computational cost. Therefore, the realization as an adapted beamformer is particularly advantageous.

A holographic reconstruction is generally necessary if due to the size of the antenna array or the bandwidth used a target appears in different bins after the range FFT. Then a hypothesis has to be made for both the target frequency and the target phase, which is computationally expensive.

The advantage with the thinned-out array considered here is that even if the target is in the near-field of the total antenna arrangement, it is in the far-field of the partial apertures formed by the apertures of the two radar units. It is particularly advantageous here that the target is then at the same range FFT bin in both cross paths. This enables a computationally efficient offsetting of cross-path spectra of both radars (radar units) using a suitable beamformer. Although the classical MIMO approach cannot be applied here if the target is in the near-field of the total antenna arrangement, with the aid of the beamformer the combination of the Tx and Rx antenna arrays can be used advantageously.

The distance information for the cross-path of an arrangement consisting of two radar units constrains the position of the target to an ellipse with the radar positions at the ellipse focal points. The ellipse parameters are as follows:

The linear eccentricity is

$$c = \frac{b}{2} ,$$

with the distance between the two radar stations b.

For a hypothetical round-trip cross-path distance d_{hyp}, e.g. from Tx (emitting antenna) of radar unit 10 to the target to Rx (receiving antenna) of radar unit 11 (or vice versa), the ellipse major axis is given by

$${a}_{hyp} = \frac{{d}_{hyp}}{2} .$$

The ellipse minor axis is

$${b}_{hyp} = \sqrt{{a}_{hyp}^{2} - {c}^{2}} ,$$

Thus, for a hypothetical azimuth angle φ_{hyp}, the hypothetical target position P_{hyp} in the Cartesian coordinate system can be calculated as follows:

$${x}_{hyp} = \frac{{a}_{hyp} {b}_{hyp} tan {φ}_{hyp}}{\sqrt{{a}_{hyp}^{2} + {b}_{hyp}^{2} {tan}^{2} {φ}_{hyp}}} ,$$

$${y}_{hyp} = \frac{{a}_{hyp} {b}_{hyp}}{\sqrt{{a}_{hyp}^{2} + {b}_{hyp}^{2} {tan}^{2} {φ}_{hyp}}} ,$$

$${p}_{hyp} = {[ {x}_{hyp} , {y}_{hyp} ]}^{T} .$$

With the position P_{Tx,n} of the Tx antenna n or P_{Rx,m} of the Rx antenna m, the round-trip distance from the respective Tx antenna to the target and from the target to the respective Rx antenna can be calculated to be

$${d}_{m , n} = {‖ {p}_{Tx , n} - {p}_{hyp} ‖}_{2} + {‖ {p}_{Rx , m} - {p}_{hyp} ‖}_{2} ,$$

with the Euclidean distance ∥•∥₂. With the ramp start frequency and bandwidth f₀ and B, or the speed of light cₒ, the phase hypothesis φ_{hyp} can be calculated:

$${ϕ}_{hyp} ( {d}_{hyp} , {φ}_{hyp} ) = 2 π \frac{{f}_{0} + 0.5 B}{{c}_{0}} {d}_{n , m} .$$

The term 0.5B accounts for the influence of a (FMCW) bandwidth on the phase.

The elements of the hypothesis vector can then be calculated as follows:

$${h}_{m , n} ( {d}_{hyp} , {φ}_{hyp} ) = exp ( - j {ϕ}_{hyp} ( {d}_{hyp} , {φ}_{hyp} ) ) .$$

The radar image I(d_{hypφhyp}) results from the comparison of the hypothesis with the measurement S_{m,n}(d_{hyp}):

$$I ( {d}_{hyp} , {φ}_{hyp} ) = {\sum }_{n = 1}^{N} {\sum }_{m = 1}^{M} {s}_{m , n} ( {d}_{hyp} ) {h}_{m , n} ( {d}_{hyp} , {φ}_{hyp} )$$

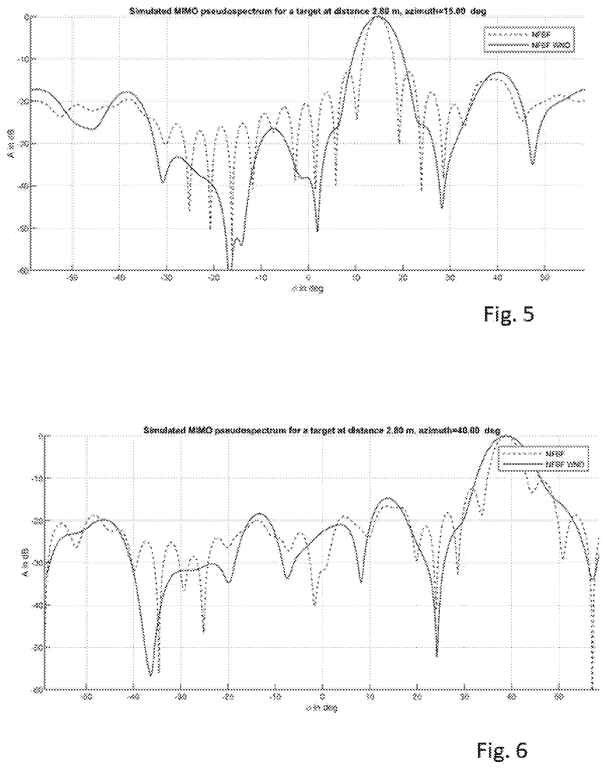

A simulation result is shown in FIGS. 5 and 6 for a target in the near-field at 15° and 40°, respectively, as “NFBF”. If one extends the beamforming by a window w (e.g., a Hann-window)

$${I}_{w n d} ( {d}_{hyp} , {φ}_{hyp} ) = {\sum }_{n = 1}^{N} {\sum }_{m = 1}^{M} {s}_{m , n} ( {d}_{hyp} ) {h}_{m , n} ( {d}_{hyp} , {φ}_{hyp} ) {w}_{m , n} ,$$

one obtains the spectrum “NFBF WND”. As can be seen, the window reduces the sidelobes in some parts of the spectrum. However, the remaining sidelobes of up to −15 dB are impermissibly high for imaging applications. This is because the combination of the two partial apertures does not produce a fully populated uniform linear array (ULA), but a thinned-out array.

To reduce the sidelobe level, optimization of the beamformer weights can be performed as described, for example, in P. Gerstoft, A. Xenaki, and C. F. Mecklenbrauker, “Multiple and single snapshot compressive beamforming,” The Journal of the Acoustical Society of America, vol. 138, no. 4, pp. 2003-214 Oct. 2015. This corresponds to a simple non-iterative compressed sensing approach or least-squares optimization.

If one combines the hypotheses for a distance and all angles into a matrix H, the optimized weights H∘ can be calculated as follows:

$${H}_{o} = H ( {H}^{H} H + μ I ) ,$$

with the regularization parameter u and the unit matrix I. The optimized weights are independent of the measured data. Therefore, they can be calculated and stored only once and then applied to each measurement. The computational effort of applying the optimized beamformer is consequently equal to that of the simplest delay-and-sum beamformer.

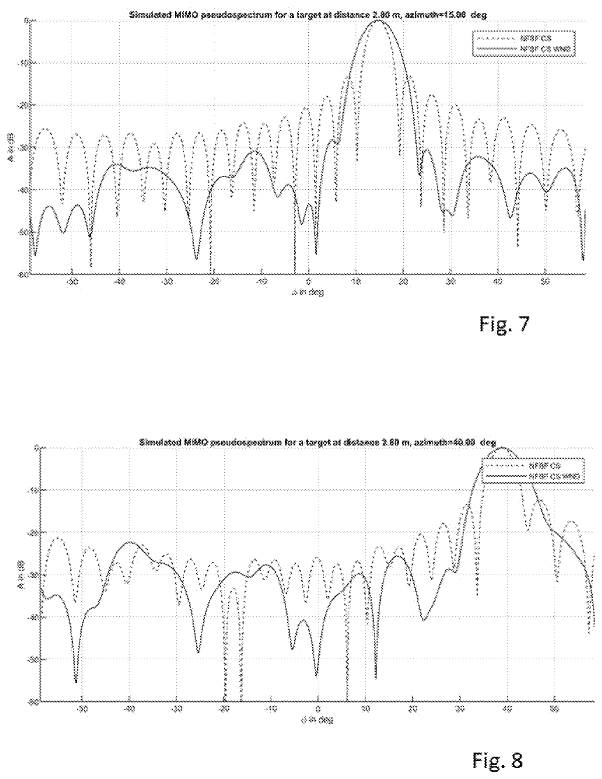

The result of applying the optimized weights is shown in FIGS. 7 and 8 as “NFBF CS” for a target in the near-field at 15° and 40°, respectively. As can be seen, by this the side lobes far from the main peak are reduced to about-25 dB. An additional windowing, e.g., with the Hann-window, results in a further reduction of the sidelobes to −35 dB at the expense of widening the main lobe.

Key points of the invention are:
1) Use of subarrays with better overall characteristics than the main array.
2) Calculation of subarrays with matched beamformer that a) takes into account that the far-field approximation does not apply to the total aperture and b) that the far-field approximation applies to a partial aperture.

These key points are considered independent and claimed solutions to the above object and may optionally be combined with features from one or more of the appended claims and/or the above description.

At this point, it should be noted that all of the above-described parts are claimed as essential to the invention when considered alone and in any combination, especially the details shown in the drawings. Modifications thereof are familiar to those skilled in the art.

### LIST OF REFERENCE SIGNS

9 radar system

10 first radar unit

11 second radar unit

12 group of virtual channels

13 group of virtual channels

14 group of virtual channels

15 emitting antenna

16 receiving antenna

What is claimed:

1. A method for evaluating signals in a radar system comprising at least one first radar unit and at least one second radar unit forming a total radar array, the method comprising:
determining a near-field distance threshold for the total radar array based on a spatial extent of the total radar array and an emitting frequency of the radar system;
determining that a range of a target to be evaluated falls below the near-field distance threshold for the total radar array;
selecting a partial radar array of the total radar array, the partial radar array having a spatial extent smaller than the total radar array; and
evaluating signals received at the partial radar array to determine a position of the target;
wherein a near-field distance threshold determined for the partial radar array is less than the range of the target.

2. The method of claim 1, wherein the near-field distance threshold for a given radar array is proportional to a square of the spatial extent of that radar array, multiplied by the emitting frequency, and divided by a propagation velocity; and
wherein the partial radar array is selected so that its near-field distance threshold is less than the range of the target.

3. The method of claim 1, wherein the partial radar array comprises virtual channels corresponding to locations between the first and second radar units by spatial folding of sub-arrays of the first and second radar units; and
wherein a spacing of the virtual channels is determined by antenna spacing within the first and second radar units rather than by the distance between the first and second radar units.

4. The method of claim 3, wherein the evaluating uses the spacing of the virtual channels as determined by the antenna spacing within the first and second radar units without requiring reference to the distance between the first and second radar units.

5. The method of claim 1, wherein the evaluating comprises combining signals received along cross-paths between the first and second radar units;
wherein a cross-path signal travels from a transmit antenna of one of the first or second radar units to a target and from the target to a receive antenna of another of the first or second radar units; and
wherein the combining uses a round-trip signal distance determined for the cross-path to align phase contributions from the cross-path signals.

6. The method of claim 5, wherein the round-trip signal distance for a cross-path is determined by constraining a hypothetical target position to lie on an ellipse having positions of the first and second radar units at focal points of the ellipse.

7. The method of claim 6, wherein a determination of the round-trip signal distance is from a transmit antenna position to the hypothetical target position on the ellipse and from the hypothetical target position to a receive antenna position.

8. The method of claim 5, wherein a determination of the round-trip signal distance accounts for a bandwidth of transmitted signals by using a center frequency of the transmitted signal rather than a single carrier frequency.

9. The method of claim 5, wherein the evaluating comprises forming a radar image by combining, over transmit-receive antenna pairs of the partial radar array, measured signals weighted by phase values derived from the round-trip signal distances for a hypothetical target position.

10. The method of claim 9, wherein the combining is further weighted by a window function applied across the transmit-receive antenna pairs of the partial radar array to reduce sidelobe levels in the radar image.

11. The method of claim 9, wherein the evaluating comprises determining beamformer weights for the partial radar array by reducing or minimizing sidelobe levels of the radar image across a set of hypothetical target positions at a hypothetical target distance;
wherein the beamformer weights are determined from phase values; and
wherein the beamformer weights are applied in the combining in place of the phase values for individual hypothetical target positions.

12. The method of claim 11, wherein the beamformer weights are determined independently of signals received during radar measurements and applied to signals from a plurality of radar measurements without requiring recomputation.

13. A radar system comprising:
at least one first radar unit and at least one second radar unit forming a total radar array; and
an evaluation device configured to:
determine a near-field distance threshold for the total radar array based on a spatial extent of the total radar array and an emitting frequency of the radar system;
determine that a range of a target falls below the near-field distance threshold for the total radar array;
select a partial radar array of the total radar array having a spatial extent smaller than the total radar array; and
evaluate signals received at the partial radar array to determine a position of the target;
wherein a near-field distance threshold determined for the partial radar array is less than the range of the target.

14. The radar system of claim 13, wherein the near-field distance threshold for a given radar array is proportional to a square of the spatial extent of that radar array, multiplied by the emitting frequency, and divided by a propagation velocity.

15. The radar system of claim 13, wherein the partial radar array comprises virtual channels corresponding to locations between the first and second radar units formed by spatial folding of sub-arrays of the first and second radar units; and
wherein a spacing of the virtual channels is determined by antenna spacing within the first and second radar units rather than by the distance between the first and second radar units.

16. The radar system of claim 15, wherein the evaluation device is configured to evaluate signals using the spacing of the virtual channels as determined by the antenna spacing within the first and second radar units without requiring reference to the distance between the first and second radar units.

17. The radar system of claim 13, wherein the evaluation device is configured to combine signals received along cross-paths between the first and second radar units;
wherein a cross-path signal travels from a transmit antenna of one of the first or second radar units to a target and from the target to a receive antenna of another of the first or second radar units; and
wherein the combining uses a round-trip signal distance determined for the cross-path to align phase contributions from the cross-path signals.

18. The radar system of claim 17, wherein the round-trip signal distance is determined by constraining a hypothetical target position to lie on an ellipse having positions of the first and second radar units at focal points of the ellipse; and
wherein the round-trip signal distance is determined from a transmit antenna position to the hypothetical target position on the ellipse and from the hypothetical target position to a receive antenna position.

19. The radar system of claim 17, wherein the evaluation device is configured to determine beamformer weights for the partial radar array by reducing sidelobe levels of a radar image across a set of hypothetical target positions at a hypothetical target distance;
wherein the beamformer weights are determined from phase values derived from round-trip signal distances for the set of hypothetical target positions; and
wherein the beamformer weights are stored in a memory of the radar system and applied to signals from a plurality of radar measurements without requiring recomputation for every set of radar measurements.

20. The radar system of claim 13, wherein the first radar unit and the second radar unit are housed on or within a vehicle, and wherein the evaluation device is housed on or within the vehicle.
